(19) United States
(12) Patent Application Publication
(10) Pub. No.: US 2026/0037927 A1
(43) Pub. Date: Feb. 5, 2026

(54) INFORMATION PROCESSING DEVICE AND INFORMATION NOTIFICATION SYSTEM

(71) Applicant: KYOCERA Document Solutions Inc., Osaka (JP)

(72) Inventors: Junpei TAKADA, Osaka (JP); Fumiya SAKASHITA, Osaka (JP); Shoichi SAKAGUCHI, Osaka (JP); Yumi HIROBE, Osaka (JP); Takuma FUJIKAWA, Osaka (JP)

(73) Assignee: KYOCERA Document Solutions Inc., Osaka (JP)

(21) Appl. No.: 19/100,727

(22) PCT Filed: Aug. 1, 2023
(86) PCT No.: PCT/JP2023/028136

§ 371 Date: Feb. 3, 2025

(30) Foreign Application Priority Data
Aug. 10, 2022 (JP) 2022-128454

(51) Int. Cl. G06Q 10/109

(52) U.S. Cl. CPC G06Q 10/109

(57) ABSTRACT

In an information notification system (Sy), an information processing device (10) on a sending side that sends an e-mail includes a controller (19) that calculates a preparation time including a travel time taken to move from a location of the information processing device (10) on a receiving side that receives the e-mail to a main conference room, wherein when the preparation time is longer than a reminder time, the controller (19) selects, based on a location of the conference room and the location of the information processing device (10) on the receiving side, an alternative conference room closer to the information processing device (10) on the receiving side than the main conference room, and allows an e-mail indicating a change to the selected alternative conference room to be sent to the information processing device (10) on the receiving side.

### TECHNICAL FIELD

The present invention relates to information processing devices and information notification systems and particularly relates to a technique for notifying of an event destination, the start date and time for the event, and so on by notification information.

### BACKGROUND ART

Generally, an information notification system is known which includes a plurality of information processing devices that send and receive via a server on a network an e-mail for notifying of a conference room, a start date and time for the conference, and so on.

For example, in a resource reservation system described in Patent Literature 1, reservation information on a reservation for a resource, such as a conference room, is acquired, a method for sending a notification about the reservation for a resource or destinations of the notification are determined according to the acquired reservation information, and the notification about the reservation for a resource is sent to terminal devices by the determined sending method or sent to the determined destinations. Thus, the notification about the reservation for a resource is sent without limitation to the person who made the reservation and like persons.

### CITATION LIST

### Patent Literature

Patent Literature 1 JP-A-2020-52699

### SUMMARY OF INVENTION

In notifying a conference room, a start date and time for the conference, and so on by e-mail, a reminder notification is often made in which a date and time earlier than the start date and time for the conference is previously designated and an e-mail for notification is sent from an information processing device on the sending side to information processing devices on the receiving side at the designated date and time. Thus, users of the information processing devices on the receiving side can read the e-mail received at the date and time earlier than the start date and time for the conference and arrive at the conference room without being late to the conference.

However, when the user has moved and is far away from the conference room on the day of the conference, the travel time taken for the user to move to the conference room is long and the user may therefore be late to the conference. In this case, if a reminder notification can be used to change the conference room to an alternative conference room close to the user, the convenience of reminder notification will increase.

Although in the technique disclosed in Patent Literature 1 the method for sending a notification about a reservation for a resource or destinations of the notification are determined according to reservation information, no notification about a change in the conference room is made.

The present invention has been made in view of the foregoing circumstances and has an object of, when a user has moved and is far away from a scheduled conference room, changing the scheduled conference room to an alternative conference room close to the user and notifying the user of the alternative conference room.

An information processing device according to one aspect of the present invention is an information processing device on a sending side that sends, for each of a plurality of event destinations, notification information notifying of an event to be held at the event destination via a server on a network to a different information processing device on a receiving side, and the information processing device on the sending side includes: a communication device that communicates with the information processing device on the receiving side via the server: an input device to which a reminder time indicating a time from a start date and time for the event to a reminder sending date and time earlier than the start date and time for the event is to be input: and a controller that calculates, at the reminder sending date and time or a predetermined time before the reminder sending date and time, a preparation time which is either a travel time taken to move from a location of the information processing device on the receiving side to the event destination or a time obtained by adding a specified time to the travel time, wherein when the preparation time is equal to or shorter than the reminder time, the controller allows the communication device to send the notification information to the information processing device on the receiving side at the reminder sending date and time, and wherein when the preparation time is longer than the reminder time, the controller selects, based on respective locations of the event destinations and the location of the information processing device on the receiving side, an alternative one of the event destinations where the preparation time is equal to or shorter than the reminder time, and allows the communication device to send notification information indicating a change to the alternative event destination to the information processing device on the receiving side.

An information notification system according to another aspect of the present invention is an information notification system including a plurality of information processing devices that communicate, for each of a plurality of event destinations, notification information notifying of an event to be held at the event destination via a server on a network, and the information notification system includes, among the plurality of information processing devices, at least the above-described information processing device according to the one aspect of the present invention as an information processing device on a sending side that sends the notification information.

### ADVANTAGEOUS EFFECTS OF INVENTION

In the present invention, when a user has moved and is far away from a scheduled conference room, it is possible to change the scheduled conference room to an alternative conference room close to the user and notify the user of the alternative conference room.

### BRIEF DESCRIPTION OF DRAWINGS

FIG. 1 is a block diagram showing the configuration of an information notification system according to an embodiment of the present invention.

FIG. 2 is a block diagram showing an essential configuration of an information processing device.

FIG. 3 is a view showing an example of a conference schedule.

FIG. 4 is a flowchart showing a control procedure of notification setting processing.

FIG. 5 is a view showing an example of a pop-up window for login.

FIG. 6 is a view showing an example of a setting window for reminder notification.

FIG. 7 is a view conceptually showing conference management data.

FIG. 8 is a view showing an example of a pop-up window for selecting whether to extend a reminder time.

FIG. 9 is a view showing another example of a pop-up window for selecting whether to extend a reminder time.

FIG. 10A is a flowchart showing a control procedure of conference room setting processing.

FIG. 10B is a flowchart showing a control procedure continued from FIG. 10A.

### DESCRIPTION OF EMBODIMENTS

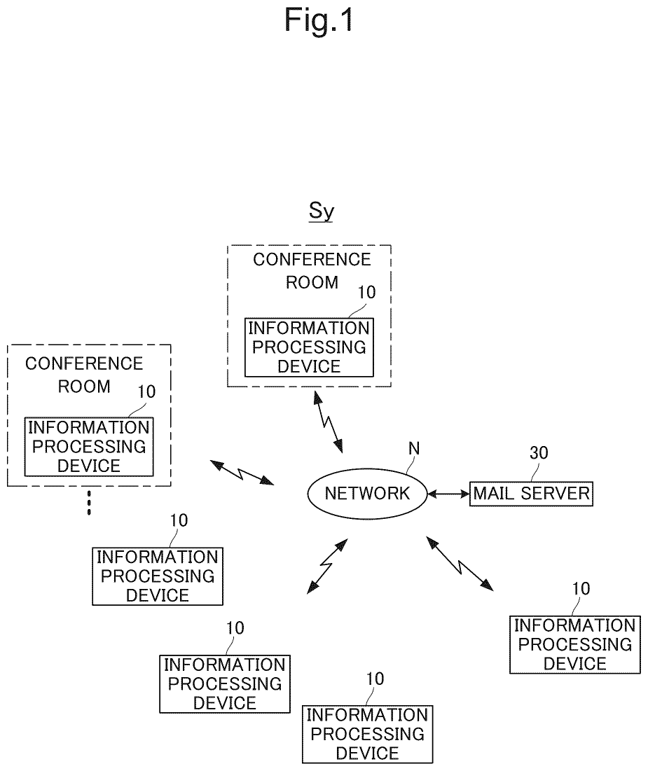

Hereinafter, a description will be given of an information processing device and an information notification system according to an embodiment of the present invention with reference to the drawings. FIG. 1 is a block diagram showing the configuration of an information notification system Sy according to an embodiment of the present invention.

The information notification system Sy includes a plurality of information processing devices 10. In the information notification system Sy, the plurality of information processing devices 10 are connected to a network (such as an intranet) N and communicate notification information between them via a server 30 (for example, a mail server, the server 30 will hereinafter be explained as a mail server) on the network N. Each of the information processing devices 10 accesses the server 30 over the network N. The notification information is information containing a message to be notified of and is, for example, an e-mail. Hereinafter, the notification information will be explained as an e-mail. The number of information processing devices 10 is not particularly limited.

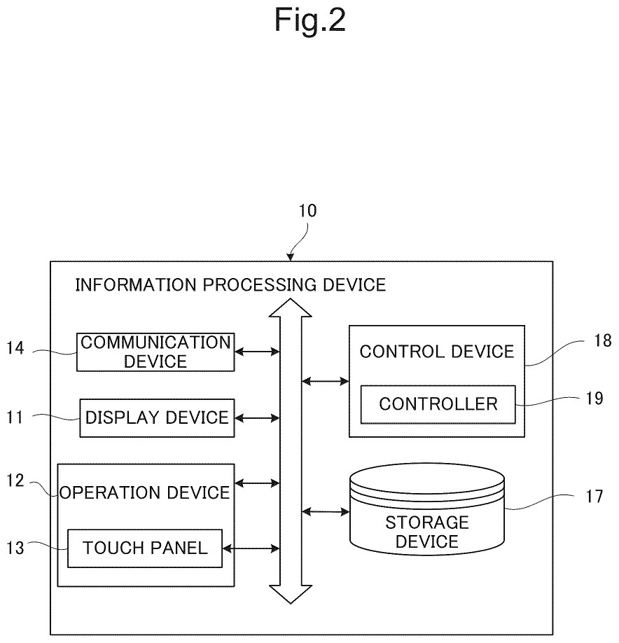

FIG. 2 is a block diagram showing an essential configuration of the information processing device 10. The information processing device 10 is, for example, a personal computer, a portable smartphone or a mobile. The information processing device 10 includes a display device 11, an operation device 12, a touch panel 13, a communication device 14, a storage device 17, and a control device 18.

The display device 11 is formed of a liquid crystal display (LCD), an organic EL (OLED: organic light-emitting diode) display or the like.

The touch panel 13 is provided to lie over the screen of the display device 11. The touch panel 13 detects a touch on the touch panel 13 with a user's finger or the like together with a point of touch and outputs a detection signal indicating the coordinate of the point of touch as a signal specifying an instruction to a controller 19 of the control device 18. Thus, through the touch panel 13, an input of an instruction based on a GUI (graphical user interface) or the like being displayed on the screen of the display device 11 can be achieved. The touch panel 13 functions as part of the operation device 12.

The operation device 12 includes a keyboard, a pointing device, physical keys or so on, all of which can be operated by the user. The operation device 12 accepts an input of an instruction according to a user's operation of the keyboard or others and outputs the accepted instruction to the controller 19. The operation device 12 is an example of an input device defined in Claims.

The communication device 14 is a communication interface including a communication module, such as a LAN (local area network) chip. The communication device 14 is connected via the network N to the server 30 and performs data communication with the server 30.

The storage device 17 is a large-capacity storage device, such as an SSD (solid state drive) or an HDD (hard disk drive). The storage device 17 stores various types of application programs and various types of data.

The control device 18 is made up of a processor, a RAM (random access memory), a ROM (read only memory), and so on. The processor is, for example, a CPU (central processing unit), an ASIC (application specific integrated circuit), an MPU (micro-processing unit) or the like. When an information notification program stored in the above-mentioned ROM or the storage device 17 is executed by the processor, the control device 18 functions as the controller 19.

The control device 18 is connected to the display device 11, the operation device 12, the touch panel 13, the communication device 14, the storage device 17, and so on. The controller 19 governs the overall control of the information processing device 10. The controller 19 performs control of the above-mentioned components and performs signal and data transfer to and from the components.

The controller 19 serves as a processor that executes various type of processing. Furthermore, the controller 19 has the function to control the display device 11 and the communication device 14.

In the information notification system Sy having the configuration described so far, for example, one of the plurality of information processing devices 10 is a PC placed in a conference room (an example of an event destination) or a PC managed by a user serving as a manager and is operated by the manager of a conference (an example of an event) (hereinafter, this information processing device 10 is referred to as a conference room information processing device 10). On the other hand, the other information processing devices 10 are PCs placed on respective desks or tables for participants participating in the conference or respective portable terminals or mobiles carried by the participants and are operated by the participants (hereinafter, these information processing devices 10 are referred to as participants' information processing devices 10).

The manager and individual participants are a plurality of users that use the information notification system Sy and their respective information processing devices 10. Alternatively, a participant may serve also as the manager.

In each of the information processing devices 10, when the information notification program for creating, sending, and receiving an e-mail is run, an e-mail is created and sent according to operations of the manager or the participant, and an e-mail is received. The e-mail is received by the server 30 on the network N and sent from the server 30 to each of the information processing devices 10.

The server 30 is connected to the network N (for example, a corporate network) and each of the information processing devices 10 is accessible to the server 30.

For example, when on the conference room information processing device 10 a predetermined icon being displayed on the display device 11 is specified by a manager's operation of the pointing device or the keyboard of the operation device 12, an instruction to run the information notification program for creating, sending, and receiving an e-mail is accepted by the operation device 12. The controller 19 executes the information notification program stored in the storage device 17 and, in accordance with the information notification program, allows the display device 11 to display on the screen a window for creating, sending, and receiving an e-mail (hereinafter, referred to as a mail window). The information notification program is an application program for creating, sending, and receiving an e-mail (for example, a program developed from Microsoft Office365 Outlook by Microsoft Corporation, but it is not intended to limit the information notification program to a program developed from Microsoft Office365 Outlook).

When the operation device 12 accepts an input of various information necessary for the operation device 12 to create an e-mail, based on manager's operations on buttons in the mail window being displayed on the screen of the display device 11 using the pointing device or keyboard of the operation device 12, the controller 19 creates, based on the information, an e-mail notifying of a conference room, a start date and time for the conference, and so on. Furthermore, the controller 19 sets the mail addresses of conference participants as destinations of the e-mail and allows the communication device 14 to send the e-mail. The e-mail is received by the server 30 via the network N and sent to the participants' information processing devices 10 by the server 30. Each of the participants executes the information notification program for creating, sending, and receiving an e-mail on their own information processing device 10 (the information processing device 10 on the receiving side). Upon receipt of the e-mail from the server 30 through the communication device 14, the controller 19 of the information processing device 10 (on the receiving side) allows the display device 11 to display a mail window on the screen and display the contents indicated by the e-mail, such as a conference room and a start date and time for the conference, in the mail window. When viewing the mail window, the users can confirm the contents indicated by the e-mail.

Furthermore, each of the users (the manager and individual participants of the conference) operates the pointing device or the keyboard of the operation device 12 on their own information processing device 10 to input to the operation device 12 a display instruction for displaying a conference schedule stored in the storage device 17. When the display instruction is input to the operation device 12, the controller 19 allows the display device 11 to display on the screen the schedule stored in the storage device 17 in accordance with the display instruction. In addition, in response to an instruction input to the operation device 12 by a user's operation, the controller 19 rewrites and updates the conference schedule. As will be described hereinafter, the conference schedule is shared among the information processing devices 10 of the users.

As just described, using the mail window function, the users (the manager and individual participants of the conference) allow the display device 11 to display the conference schedule on the screen, update the conference schedule, and share the conference schedule among the information processing devices 10.

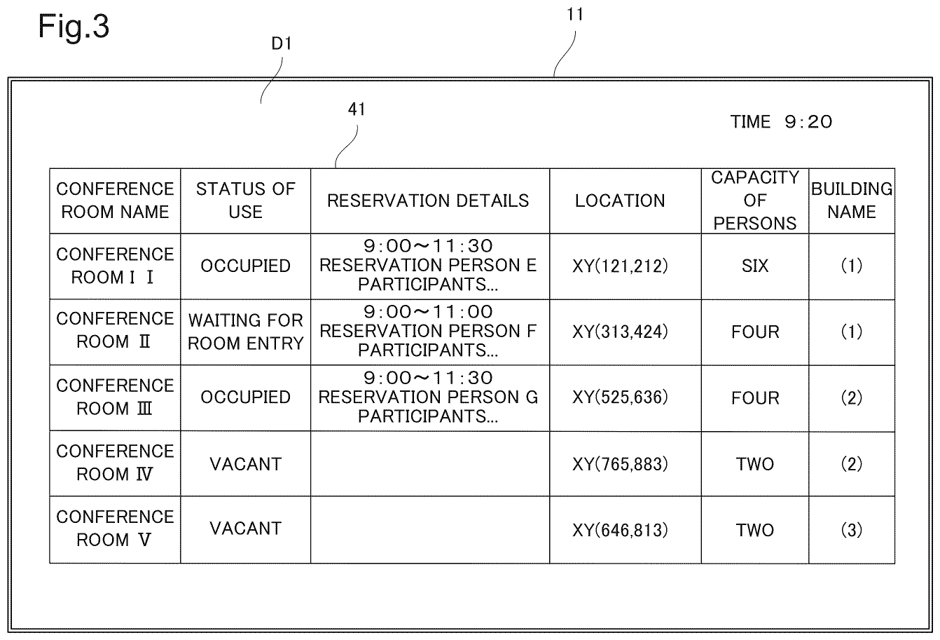

FIG. 3 shows an example of a conference schedule displayed on the screen of the display device 11. The conference schedule 41 shown in FIG. 3 includes, for each of a plurality of conference rooms, the name of conference room (Conference Room Name I, II, III . . . ), the status of use of conference room (information about whether the conference room is reserved, occupied, vacant or so on), reservation details (information that the conference room has been reserved, the scheduled time, information about a person who made the reservation, and information about participants of the conference to be held in the conference room), the capacity of persons in conference room, the location of conference room, and the site where the conference room is located (the building name (1), (2), (3), . . . ). Referring to the schedule 41 about the status of use of conference room, each of the conference rooms is Occupied, Waiting for Room Entry or Vacant. The reservation details are entered in the case where the conference room has been reserved and include the starting time and ending time of a conference, the name of a person who made the reservation, and participants. The capacity of persons in conference room is the number of persons previously set for each conference room. The name of conference room and the information on location of conference room are input by user's operations of the operation device 12 on the information processing device 10 and stored into the schedule 41 by the controller 19.

In the information notification system Sy according to this embodiment, in the case where the information processing device 10 notifies of a conference room, a start date and time for the conference, and others by an e-mail, a reminder notification is made in which the e-mail is sent from, for example, the conference room information processing device 10 to the participants' information processing devices 10 at a predetermined reminder sending date and time earlier than (for example, 10 minutes before) the start date and time for the conference, and, thus, the participants are notified in advance that the conference is scheduled to start.

Furthermore, if a participant has moved and is far away from the conference room around the reminder sending time on the day of the conference, the travel time it takes for the participant to move to the conference room is long and the participant may therefore be late to the conference. To cope with this, when a participant has moved and is far away from the conference room around the reminder sending time on the day of the conference, the conference room information processing device 10 reselects an alternative conference room closer to the participant and makes a reminder notification in which an e-mail indicating the alternative conference room is sent from the conference room information processing device 10 to the participant's information processing device 10 before the start date and time for the conference, thus notifying the participant of a change to the alternative conference room.

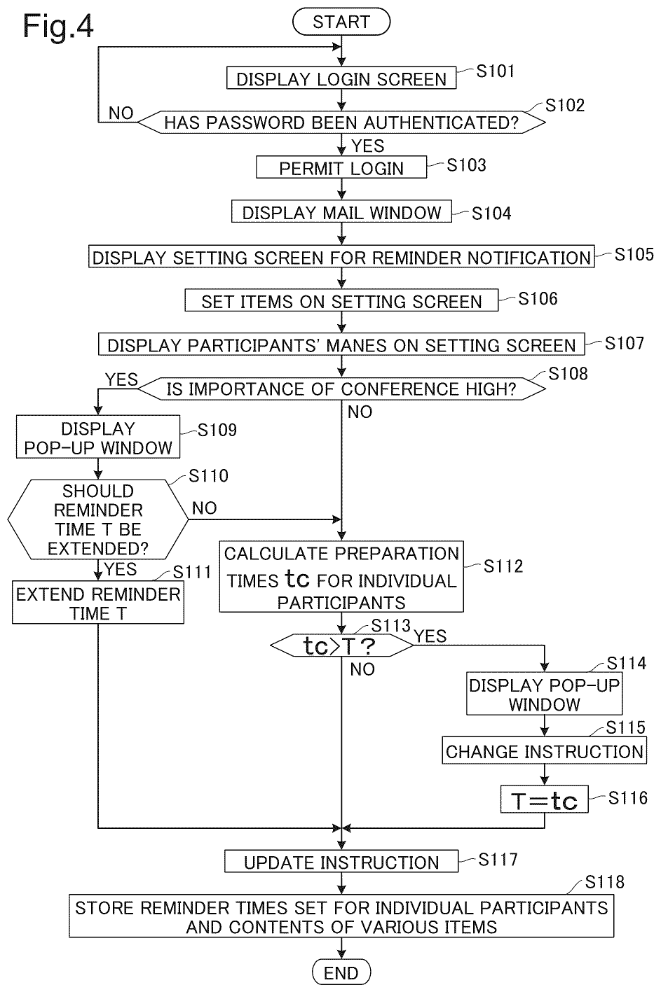

Next, a description will be given of a control procedure of notification setting processing for setting a reminder notification made before the start date and time for a conference, with reference to the flowchart shown in FIG. 4 and others.

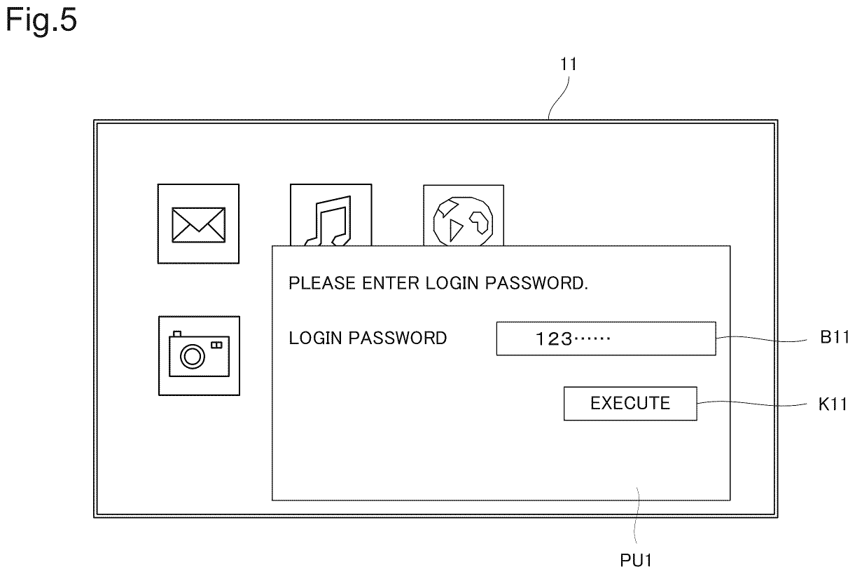

When on the conference room information processing device 10 a predetermined icon being displayed on the display device 11 is specified by a manager's operation of the pointing device or the keyboard of the operation device 12, an instruction to run the information notification program for creating, sending, and receiving an e-mail is accepted by the operation device 12. In accordance with this instruction, the controller 19 allows the display device 11 to display a pop-up window PUI for login like that shown in FIG. 5 (step S101). In the pop-up window PUI for login, a text box B11 into which a login password for the manager is to be entered and an Execute key K11 are displayed.

The manager operates the pointing device or the keyboard of the operation device 12 to enter the login password for the manager. The controller 19 of the conference room information processing device 10 allows the entered login password to be displayed in the text box B11 of the pop-up window PUI. When the manager then operates the Execute key K11, the controller 19 determines whether or not the login password displayed in the text box B11 matches the login password of the manager previously stored in the storage device 17 (step S102). When determining that the passwords match (“Yes” in step S102), the controller 19 permits a login of the manager (step S103) and executes the information notification program stored in the storage device 17. The controller 19 allows the display device 11 to display a mail window in accordance with the information notification program (step S104).

On the other hand, when the controller 19 of the conference room information processing device 10 determines that the login password displayed in the text box B11 does not match the login password of the manager previously stored in the storage device 17 (“No” in step S102), the controller 19 neither executes the information notification program instructed through the operation device 12 nor allows the display device 11 to display a mail window.

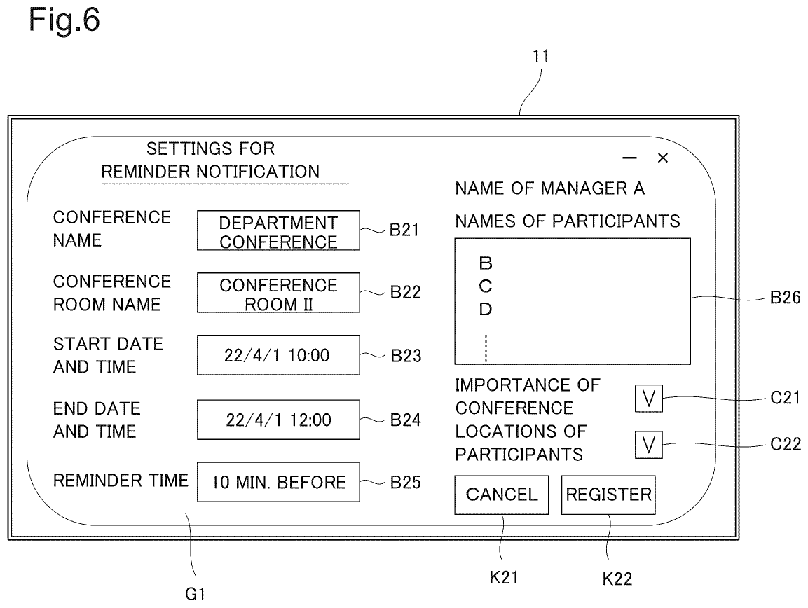

After step S104, the manager operates the pointing device or the keyboard of the operation device 12 to give an instruction to execute a reminder notification by e-mail using the function of the mail window. In response to the instruction to execute a reminder notification, the controller 19 of the conference room information processing device 10 allows the display device 11 to display on the screen a setting window G1 for reminder notification like that shown in FIG. 6 (step S105).

The setting window G1 for reminder notification shown in FIG. 6 displays: a text box B21 where a conference name is to be shown; a text box B22 where a conference room name is to be shown; a text box B23 where a start date and time for a conference is to be shown: a text box B24 where an end date and time for the conference is to be shown: a text box B25 where a reminder time T from a reminder sending date and time to the start date and time for the conference is to be shown; a text box B26 where participants' names are to be shown; a check box C21 where an instruction of whether or not the conference is important is to be accepted: a check box C22 where an instruction of whether to associate the locations of participants with the reminder notification is to be accepted: a Cancel key K21, and a Register key K22.

The manager operates the pointing device or the keyboard of the operation device 12 to select each of the text boxes B21 to B25 in the setting window G1 for reminder notification and enter a conference name, a conference room name, a start date and time for the conference, an end date and time for the conference, and a reminder time T from a reminder sending date and time to the start date and time for the conference into the respective associated text boxes B21 to B25 (step S106). The reminder time T is a period of time from the start date and time for a conference to the reminder sending date and time earlier than the start date and time. Furthermore, if necessary, the manager operates the operation device 12 to input an instruction to take the locations of participants into consideration and an instruction indicating that the level of importance of the conference is high (step S106). The above contents entered are accepted by the operation device 12 and output from the operation device 12 to the controller 19. FIG. 6 shows an example where a conference name “Department Conference” is shown in the text box B21, a conference room name “Conference Room II” is shown in the text box B22, a start date and time “22/4/1 10:00” is shown in the text box B23, an end date and time “22/4/1 12:00” is shown in the text box B24, and a reminder time T “10 min.” is shown in the text box B25.

Furthermore, FIG. 6 shows an example where both of an instruction to take the locations of the participants into consideration and an instruction indicating that the level of importance of the conference is high are input and the controller 19 allows check marks to be placed into the respective check boxes C21 and C22.

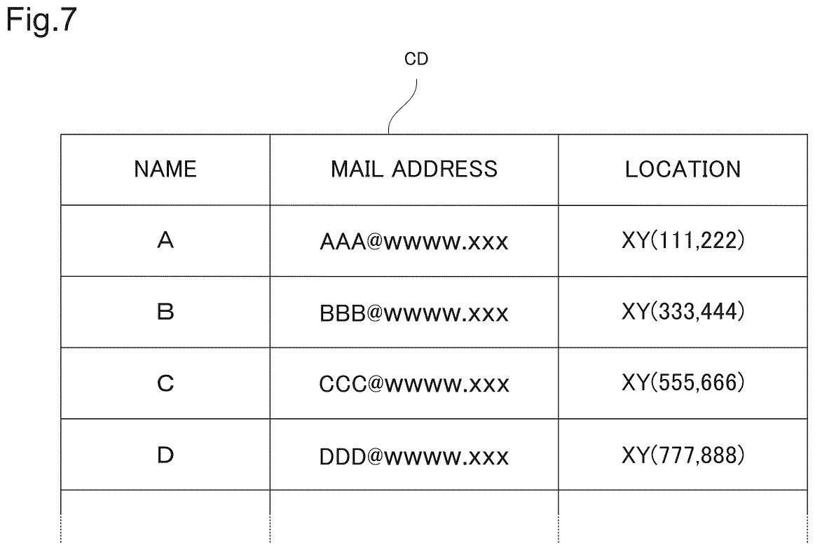

Moreover, the manager operates the pointing device or the keyboard of the operation device 12 to input, through the setting window G1 for reminder notification, an instruction to display a list of the names of a plurality of users to the operation device 12. Conference management data CD like that shown in FIG. 7 is stored in the storage device 17. The controller 19 of each of the information processing devices 10 operates in accordance with the information notification program to perform an information sharing function. Among the information processing devices 10 including the conference room information processing device 10, a conference schedule to be described hereinafter and the conference management data CD are shared through the network N and the server 30 by the information sharing function. Specifically, each of the information processing devices 10 receives, through its own communication device 14, the conference schedule and the conference management data CD stored in each of the other information processing devices 10, updates its own conference schedule and conference management data CD to the received conference schedule and conference management data CD as needed, and stores the update in the storage device 17. In other words, the information processing devices 10 synchronize their conference schedules and conference management data CD among themselves by the information sharing function and, after the synchronization, the same conference schedule and the same conference management data CD are stored in the information processing devices 10. The controller 19 of each of the information processing devices 10 writes or rewrites information on the conference schedule and the conference management data CD using information input by the operation of the operation device 12 of the information processing device 10. In the case where the information notification program used is, for example, a program developed from Microsoft Office365 Outlook by Microsoft Corporation, the above information sharing function is a file sharing function.

The conference management data CD stores, for example, the names of a plurality of users (including a manager and conference participants), the mail addresses of the users (an example of destination information indicating destinations to send notification information), and the respective locations of the information processing devices 10 of the users. The controller 19 of the conference room information processing device 10 reads the names of all the users (including the manager and conference participants) from the conference management data CD and allows the display device 11 to display a list of the users' names, for example, in a separate window different from the setting window G1 on the screen.

During the display of the separate window, the manager operates the pointing device or the keyboard of the operation device 12 to select from the list of the users' names the names of participants who will participate in the conference. According to this operation, the controller 19 accepts through the operation device 12 a selection instruction on the selected participants. Upon acceptance of the selection instruction, the controller 19 of the conference room information processing device 10 hides the separate window and allows the names of the participants specified by the selection instruction to be displayed in the text box B26 in the setting window G1 for reminder notification (step S107).

Each of the users' mail addresses in the conference management data CD is a mail address previously set on the information processing device 10 of the user and stored in the storage device 17 of the information processing device 10 of the user. Then, by the above-described synchronization among the information processing devices 10, the same conference management data CD is stored in the storage devices 17 of all the users' information processing devices 10.

Each of the locations of the users' information processing devices 10 in the conference management data CD is a location detected by the information processing device 10 of the user and stored in the conference management data CD of the user. For example, when an information processing device 10 is a portable terminal device or a mobile, the location of the information processing device 10 is detected by a GPS (global positioning system) function integrated into the information processing device 10. When an information processing device 10 is a desktop PC (personal computer), the location of the information processing device 10 is detected based on the reception level of a beacon signal sent from a Wi-Fi (registered trademark) base unit and received by the communication device 14 of the information processing device 10. The controller 19 rewrites the corresponding location information in data CD1 to the detected location of the information processing device 10. Alternatively, location information input by the user's operation of the operation device 12 of the information processing device 10 may be set as the location of the information processing device 10.

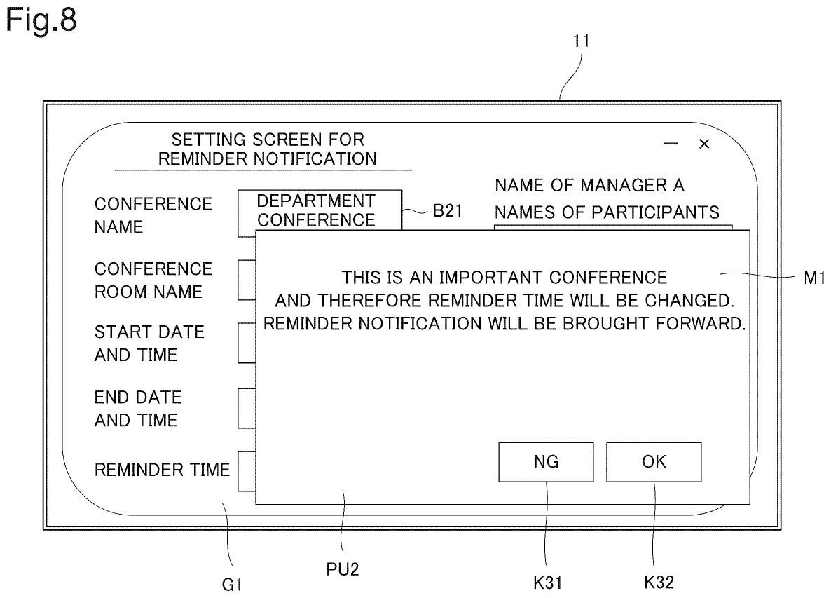

Subsequently, the controller 19 of the conference room information processing device 10 determines whether or not an instruction indicating that the level of importance of the conference is high has been accepted (step S108). When determining that an instruction indicating that the level of importance of the conference is high has been accepted (“Yes” in step S108), the controller 19 allows the display device 11 to display a pop-up window PU2 for selecting whether to extend the reminder time T (the time from the reminder sending date and time to the start date and time for the conference) for each of the participants' information processing devices 10, like that as shown in FIG. 8 (step S109). In the pop-up window PU2, a message MI indicating that the reminder time T will be changed, an NG key K31, and an OK key 32 are displayed.

When the manager operates the pointing device or the keyboard of the operation device 12 to select the OK key 32 in the pop-up window PU2, an extension instruction to extend the reminder time T is accepted by the operation device 12 (“Yes” in step S110). The controller 19 previously sets, for example, a standard reminder time T to a predetermined time (10 minutes in this case). The controller 19 sets a predetermined extension time td (for example, 5 minutes) that will be added to the reminder time T in accordance with the extension instruction. Thus, the controller 19 extends the reminder time T for the participants' information processing devices 10 from “10 minutes” to “15 minutes” (step S111). After the extension of the reminder time T, the controller 19 hides the pop-up window PU2. Thereafter, the controller 19 goes to the processing in step S117. As described above, when the level of importance of a conference is high, the reminder time T for the participants' information processing devices 10 is extended from “10 minutes” to “15 minutes”.

On the other hand, when the manager operates the pointing device or the keyboard of the operation device 12 to select the NG key 31 in the pop-up window PU2, an instruction not to extend the reminder time T is accepted by the operation device 12 (“No” in step S110). In this case, the controller 19 of the conference room information processing device 10 does not execute the processing in step S111 and keeps the reminder time T as it is. Then, the controller 19 hides the pop-up window PU2. Thereafter, the controller 19 goes to the processing in step S112.

Also when determining that no instruction indicating that the level of importance of the conference is high has been accepted (“No” in step S108), the controller 19 of the conference room information processing device 10 keeps the reminder time T for the participants' information processing devices 10 as it is because the level of importance of the conference is not high. Thereafter, the controller 19 goes to the processing in step S112.

Subsequently, the controller 19 of the conference room information processing device 10 acquires the location of the conference room with reference to the conference schedule 41 and acquires, with reference to the conference management data CD, the respective locations of the information processing devices 10 of the participants (i.e., the selected participants) being displayed in the text box B26.

The conference schedule 41 like that shown on a reservation display screen DI in FIG. 3 is stored in the storage device 17. The controller 19 of each of the information processing devices 10 operates in accordance with the information notification program to perform an information sharing function. Among the information processing devices 10 including the conference room information processing device 10, a conference schedule is shared through the network N and the server 30 by the information sharing function. Specifically, each of the information processing devices 10 receives, through its own communication device 14, the conference schedule stored in each of the other information processing devices 10, updates its own conference schedule to the received conference schedule as needed, and stores the update in the storage device 17. In other words, the information processing devices 10 synchronize their conference schedules among themselves by the information sharing function and, after the synchronization, the same conference schedule is stored in the information processing devices 10. The controller 19 of each of the information processing devices 10 writes or rewrites information on the conference schedule using information input by the operation of the operation device 12 of the information processing device 10.

After the acquisition of the location of the conference room and the respective locations of the participants' information processing devices 10 in the above manner, the controller 19 calculates the respective distances from the locations of the participants' information processing devices 10 to the location of the conference room, calculates, based on these distances, the respective travel times ta it takes for the individual participants to move to the conference room using a predetermined standard walking speed, and adds a predetermined specified time tb to each of the travel times ta to calculate respective preparation times tc for the individual participants' information processing devices 10 (step S112). Alternatively, the controller 19 may not add the specified time tb to the travel times ta and may calculate the travel times ta themselves as the preparation times tc.

The preparation time tc for each of the participants' information processing devices 10 is calculated, on a per-participant basis, as the time it takes for the participant to prepare for the conference and move to the conference room from when the participant's information processing device 10 has received a reminder notification.

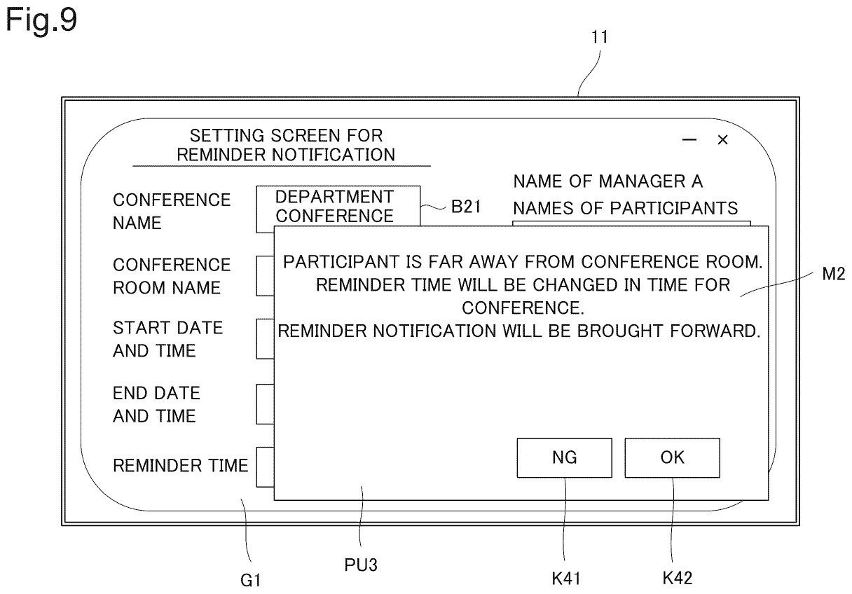

The controller 19 of the conference room information processing device 10 compares, for each of the preparation times tc for the participants' information processing devices 10, the preparation time tc with the reminder time T to determine whether or not the preparation time tc is longer than the reminder time T (step S113). When the preparation time tc is longer than the reminder time T, even if the user leaves for the conference room at the time of receipt of a reminder notification, the user will be late to or miss the conference, i.e., the user has an insufficient reminder time T. Therefore, when the preparation time tc is longer than the reminder time T (“Yes” in step S113), the controller 19 allows the display device 11 to display a pop-up window PU3 for selecting whether to extend the reminder time T for the participant's information processing device 10, like that shown in FIG. 9 (step S114). In the pop-up window PU3, a message M2 indicating that the reminder time T will be changed, an NG key K41, and an OK key 42 are displayed.

When the manager operates the pointing device or the keyboard of the operation device 12 to select the OK key 42 in the pop-up window PU3, an instruction to change the notification time is accepted by the operation device 12 (“Yes” in step S115). In accordance with the instruction to change the notification time, the controller 19 of the conference room information processing device 10 extends, regarding the participant's information processing device 10 for which the preparation time tc has been determined to be longer than the reminder time T, the reminder time T so that the preparation time tc is equal to or shorter than the reminder time T (step S116). For example, the controller 19 extends the reminder time T and thus changes the reminder sending date and time to a date and time in which the preparation time tc is equal to the reminder time T. When extending the reminder time T, the controller 19 hides the pop-up window PU3. Thereafter, the controller 19 goes to the processing in step S117. Alternatively, in step S116, the controller 19 may add the above-mentioned extended portion of the extended reminder time T to the respective reminder times T for all the participants' information processing devices 10, thus extending the reminder times T for all the participants' information processing devices 10.

Therefore, in the case where a participant is far away from the conference room and will be late to the conference even if the participant leaves for the conference room, the reminder time T is extended to a preparation time tc it takes for the participant to prepare for the conference and move to the conference room from when the participant's information processing device 10 has received a reminder notification, or a time longer than the preparation time tc.

On the other hand, when in S113 the preparation time tc is equal to or shorter than the reminder time T (“No” in step S113), the controller 19 of the conference room information processing device 10 keeps the reminder time T as it is because the preparation time tc is long enough. The controller 19 goes to the processing in step S117.

As thus far described, for each of the participants' information processing devices 10, the reminder time T is, if insufficient, extended to the preparation time tc and, when sufficient, kept unextended.

When the settings of various items in the setting window G1 for reminder notification are completed, the manager operates the pointing device or the keyboard of the operation device 12 to select the Register key K22. According to this operation, the controller 19 accepts through the operation device 12 an update instruction (step S117).

When accepting the update instruction, the controller 19 of the conference room information processing device 10 updates the reminder times T set for the individual participants' information processing devices 10 in the above manner and the setting contents of the items in the setting window G1 for reminder notification and allows the storage device 17 to store them (step S118). Thereafter, the controller 19 ends the notification setting processing.

When the manager operates the Cancel key K21 in the setting window G1 for reminder notification, the controller 19 of the conference room information processing device 10 overrides the settings of various items in the setting window G1 for reminder notification and then ends the notification setting processing shown in FIG. 4.

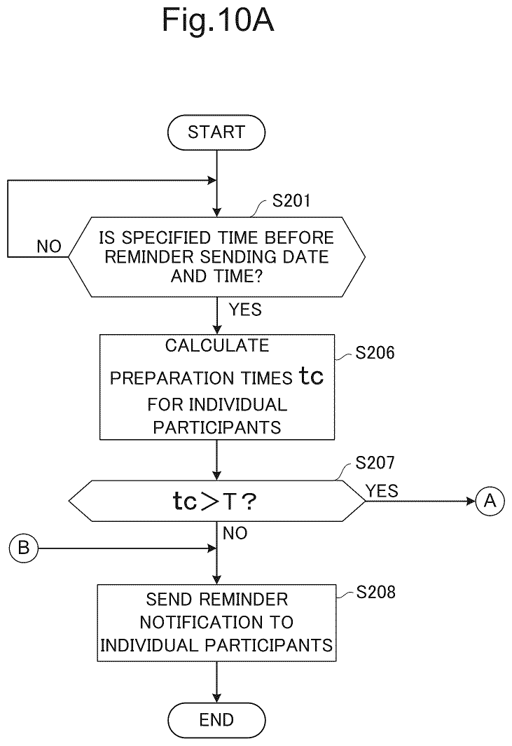

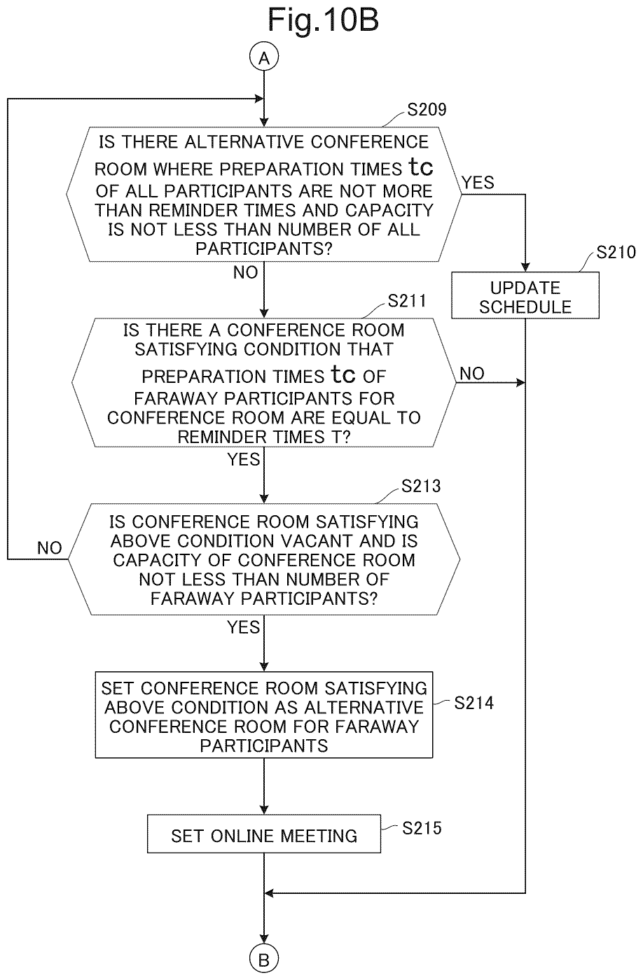

Next, a description will be given of a control procedure of conference room setting processing in which when a participant is far away from a scheduled conference room where a conference will be held (hereinafter, referred to as a main conference room) on the day of the conference, an alternative conference room more suitable for the participant is offered and the participant is notified of the alternative conference room by a reminder notification, with reference to the flowchart shown in FIGS. 10A and 10B.

Regarding the reserved conference room among the conference rooms listed in the conference schedule 41, the controller 19 of the conference room information processing device 10 calculates, for each of the respective reminder times T for the participants' information processing devices 10, a date and time the reminder time T before the start date and time for the conference as a reminder sending date and time. For example, the controller 19 determines, according to the counting of a timer built in the control device 18, whether or not a predetermined time before the earliest of the participants' reminder sending dates and times (for example, five minutes before the earliest reminder sending date and time) has been reached (step S201).

When determining that the predetermined time before the reminder sending date and time has been reached (“Yes” in step S201), the controller 19 acquires the location of the relevant conference room (hereinafter, referred to as a main conference room) with reference to the conference schedule 41 being stored in the storage device 17 at this point in time and acquires the respective locations of the participants' information processing devices 10 with reference to the conference management data CD. The controller 19 calculates the respective distances from the respective locations of the participants' information processing devices 10 at this point in time to the location of the main conference room, calculates, based on these distances, the respective travel times ta it takes for the individual participants to move to the main conference room, and calculates, based on the travel times ta, respective preparation times tc for the individual participants' information processing devices 10 (step S206).

The controller 19 of the conference room information processing device 10 compares the respective reminder times T for the participants' information processing devices 10 read from the schedule 41 being stored in the storage device 17 at this point in time with the respective preparation times tc for the participants' information processing devices 10 calculated in step S206 to determine whether or not each of the preparation times tc is longer than the associated reminder time T (step S207). When each preparation time tc is equal to or shorter than the associated reminder time T (“No” in step S207), the controller 19 keeps the main conference room unchanged because the respective preparation times tc are long enough and every individual participant can attend the conference in the main conference room in time. In this case, for each individual participant's information processing device 10, when the current time reaches the reminder sending date and time, the controller 19 creates an e-mail of reminder notification for the mail address of the participant for which the reminder sending date and time has been set and allows the communication device 14 to send the e-mail (step S208).

When, in each individual participant's information processing device 10, the communication device 14 receives the e-mail of reminder notification, the controller 19 notifies of the receipt of the e-mail by an alert function and allows the display device 11 to display the e-mail on the screen. The individual participant can confirm, at the reminder sending date and time the reminder time T before the start date and time for the conference, the e-mail of reminder notification received by its own information processing device 10 and thus can attend the conference in time.

On the other hand, when determining that at least one of the preparation times tc for the participants' information processing devices 10 is longer than the associated reminder time T (“Yes” in step S207), the controller 19 of the conference information processing device 10 goes to the processing in step S209 and subsequent steps for changing the conference room.

For example, when, because at least one of the participants moves far from the main conference room, the distance from the location of the information processing device 10 of the participant far from the main conference room to the main conference room is long and the preparation time tc for the participant's information processing device 10 therefore has become longer than the reminder time T, the participant may be late to the conference in the main conference room even if an e-mail of reminder notification is sent at the reminder sending date and time the reminder time T before the start date and time for the conference. To cope with this, the controller 19 goes to the processing in step S209 and subsequent steps for changing the place where the conference will be held from the main conference room to a conference room located where any participant far away from the main conference room can meet the start time for the conference.

The controller 19 of the conference room information processing device 10 calculates, based on the locations of the information processing devices 10 of all the participants including any participant far away from the main conference room and the respective locations of the conference rooms read from the schedule 41, the respective preparation times tc of all the participants for each of the conference rooms, and compares the calculated preparation times tc with the respective associated reminder times T for each of the conference rooms to determine whether or not there is an alternative conference room where the preparation times tc of all the participants are equal to or shorter than the respective associated reminder times T and the capacity is equal to or greater than the number of the participants (step S209).

When determining that there is an alternative conference room where the preparation times tc of all the participants are equal to or shorter than the respective associated reminder times T and the capacity is equal to or greater than the number of the participants (“Yes” in step S209), the controller 19 changes the conference room from the main conference room to the alternative conference room, reflects the change in the schedule 41, and updates the schedule 41 (step S210).

On the other hand, when determining that there is no alternative conference room where the preparation times tc of all the participants are equal to or shorter than the respective associated reminder times T and the capacity is equal to or greater than the number of the participants (“No” in step S209), the controller 19 calculates, based on the location of the information processing device 10 of each participant far away from the main conference room and the respective locations of the conference rooms read from the schedule 41, the respective preparation times tc of each participant far away from the main conference room for the respective conference rooms, and compares the calculated preparation times tc of each participant far away from the main conference room with the respective associated reminder times T to determine whether or not there is a conference room satisfying a condition that the preparation time tc of each participant far away from the conference room is equal to or shorter than the associated reminder time T (step S211).

When there is no conference room satisfying the above condition in step S211 (“No” in step S211), the controller 19 keeps the conference room unchanged from the main conference room and goes to the processing in step S208 wherein the controller 19 creates e-mails of reminder notification for the mail addresses of the participants while keeping the settings for the main conference room entered in the schedule 41 unchanged and allows the communication device 14 to send the e-mails (step S208). Alternatively, in step S208, the controller 19 may create, as e-mails for reminder notification for the participants' mail addresses, e-mails indicating that there is no conference room where every participant can arrive in time at the start time of the conference and allow the communication device 14 to send the e-mails.

When there is a conference room satisfying the above condition in step S211 (“Yes” in step S211), the controller 19 determines whether or not the conference room satisfying the above condition is vacant and the capacity of the conference room is equal to or greater than the number of participants far away from the main conference room (step S213).

When determining that the conference room satisfying the above condition is vacant and the capacity of the conference room is equal to or greater than the number of participants far away from the main conference room (“Yes” in step S213), the controller 19 sets the conference room satisfying the above condition as an alternative conference room for every participant far away from the main conference room (step S214). When, like the case as just described, there are a plurality of participants far away from the main conference room, the controller 19 may instead determine, for the individual participant, whether there is a conference room satisfying the above condition and set an alternative individual conference room for the individual participant far away from the main conference room. The controller 19 keeps the main conference room as a conference room for the participants other than participants far away from the main conference room.

After step S214, i.e., when an alternative conference room is set for each participant far away from the main conference room, the controller 19 sets an online meeting for the information processing devices 10 of all the participants including every participant far away from the main conference room and creates information for participation in the online meeting (such as a URL (uniform resource locator) where the online meeting will be held) (step S215). Thereafter, the controller 19 goes back to the processing in step S208. In step S208, the controller 19 creates e-mails for reminder notification containing the information for participation in the online meeting and allows the communication device 14 to send the e-mails to the respective information processing devices 10 of all the participants. In creating the e-mails, the controller 19 creates, for any participant far away from the main conference room, an e-mail indicating that the conference room for the participant is the alternative conference room, and creates, for each of the participants other than those far away from the main conference room, an e-mail indicating that the conference room for the participant remains unchanged from the main conference room.

When determining that the conference room satisfying the above condition is vacant and the capacity of the conference room is neither equal to nor greater than the number of participants far away from the main conference room (“No” in step S213), the controller 19 goes back to the processing in step S209. In this case, the controller 19 repeats the above processing until, as a result of subsequent movement of the participants, the controller 19 determines that there is an alternative conference room where the preparation times tc of all the participants are equal to or shorter than the respective associated reminder times T and the capacity is equal to or greater than the number of the participants (“Yes” in step S209), determines that the conference room satisfying the above condition is vacant and the capacity of the conference room is equal to or greater than the number of participants far away from the main conference room (“Yes” in step S213) or determines in step S211 that there is no conference room satisfying the above condition (“No” in step S211).

Next, a description will be given of a first modification of the conference room setting processing.

In the control procedure shown in FIG. 10B, when determining that at least one of the preparation times tc for the participants' information processing devices 10 is longer than the associated reminder time T (“Yes” in step S207) and further determining that there is an alternative conference room where the preparation times tc of all the participants are equal to or shorter than the respective associated reminder times T and the capacity is equal to or greater than the number of the participants (“Yes” in step S209), the controller 19 of the conference room information processing device 10 sets the alternative conference room as a conference room for the participants far away from the main conference room (step S210) and keeps the main conference room as a conference room for the participants other than those far away from the main conference room. However, in this case, the controller 19 may also change the conference room for the participants other than those far away from the main conference room.

For example, when the main conference room is Conference Room II in the schedule 41 shown in FIG. 3 and the number of participants far away from the main conference room is two, the number of participants other than those far away from the main conference room is two. If in this case the conference room for the participants other than those far from the main conference room is kept unchanged from the main conference room (having a capacity of four persons), the conference room having a large capacity will be occupied by a small number of persons. Therefore, in the first modification, when such a case arises, the controller 19 determines, based on the schedule 41, whether or not there is a conference room satisfying a condition that the preparation times tc of the participants other than those far away from the main conference room are equal to or greater than the respective associated reminder times T and the capacity is smaller than the capacity of the main conference room and equal to or greater than the number of the participants. When there is a conference room satisfying this condition, the controller 19 sets this conference room as an alternative conference room for the participants.

Thus, it can be avoided that even when the number of participants who will use the main conference room decreases, the main conference room having a large capacity is occupied by a small number of persons.

Subsequently, a description will be given of a second modification of the conference room setting processing.

In setting an alternative conference room for any participant far from the main conference room and an alternative conference room for the other participants in the first modification, it is possible that the controller 19 selects, based on the schedule 41, conference rooms located within a predetermined short distance from the main conference room (for example, conference rooms the locations of which indicate that they are located in the same building as the building where the main conference room is located) as candidates for alternative conference rooms, then selects, from among the selected candidates for conference rooms, a conference room satisfying a condition for an alternative conference room for any participant far away from the main conference room and a conference room satisfying a condition for an alternative conference room for the participants other than those far away from the main conference room, and sets the selected conference rooms as respective alternative conference rooms.

Furthermore, a description will be given of a third modification of the conference room setting processing.

When, in the control procedure shown in FIG. 10B, determining that at least one of the preparation times tc for the participants' information processing devices 10 is longer than the associated reminder time T (“Yes” in step S207), the controller 19 of the conference room information processing device 10 creates, based on the locations of the participants at this point in time, a plurality of participant groups each consisting of participants located close to each other, and sets, based on the schedule 41 and for each of the participant groups, a conference room closest to all the participants belonging to the group and satisfying a condition that the preparation times tc of the participants are equal to or shorter than the respective associated reminder times T and the capacity is equal to or greater than the number A of all the participants belonging to the group and closest to the number A as an alternative conference room.

Moreover, a description will be given of a fourth modification of the conference room setting processing.

When, in the control procedure shown in FIG. 10B, determining that at least one of the preparation times tc for the participants' information processing devices 10 is longer than the associated reminder time T (“Yes” in step S207), the controller 19 of the conference room information processing device 10 may allow the display device 11 to display a message requesting to approve a change in the conference room and set, on condition that an instruction indicating the approval of the change in the conference room has been input to the operation device 12, an alternative conference room for any participant far away from the main conference room. In this case, when an instruction indicating the approval of the change in the conference room is not input to the operation device 12, the controller 19 does not perform processing for setting an alternative conference room for any participant far away from the main conference room and keeps the main conference room set as a conference room for all the participants.

The present invention is not limited to the configuration of the above embodiment and can be modified in various ways. Furthermore, the configuration and processing described in the above embodiment with reference to FIGS. 1 to 10B are merely illustrative of the present invention and are not intended to limit the present invention to the above configuration and processing.

1. An information processing device on a sending side that sends, for each of a plurality of event destinations, notification information notifying of an event to be held at the event destination via a server on a network to a different information processing device on a receiving side, the information processing device on the sending side comprising:
a communication device that communicates with the information processing device on the receiving side via the server:
an input device to which a reminder time indicating a time from a start date and time for the event to a reminder sending date and time earlier than the start date and time for the event is to be input: and
a controller that calculates, at the reminder sending date and time or a predetermined time before the reminder sending date and time, a preparation time which is either a travel time taken to move from a location of the information processing device on the receiving side to the event destination or a time obtained by adding a specified time to the travel time,
wherein when the preparation time is equal to or shorter than the reminder time, the controller allows the communication device to send the notification information to the information processing device on the receiving side at the reminder sending date and time, and
wherein when the preparation time is longer than the reminder time, the controller selects, based on respective locations of the event destinations and the location of the information processing device on the receiving side, an alternative one of the event destinations where the preparation time is equal to or shorter than the reminder time, and allows the communication device to send notification information indicating a change to the alternative event destination to the information processing device on the receiving side.

2. The information processing device according to claim 1,
wherein when the information processing device on the receiving side comprises a plurality of information processing devices, the controller calculates the preparation time for each of the plurality of information processing devices on the receiving side, and
when the preparation time for any one of the plurality of information processing devices on the receiving side is longer than the reminder time, the controller selects an alternative event destination where the preparation times for all the plurality of information processing devices on the receiving side are equal to or shorter than the reminder time, and allows the communication device to send to the information processing devices on the receiving side notification information indicating a change to the alternative event destination.

3. The information processing device according to claim 2,
further comprising a display device,
wherein when the preparation time of any one of the plurality of information processing devices on the receiving side is longer than the reminder time, the controller allows the display device to display a message requesting to give approval of a change to an alternative event destination, and
when the approval is input to the input device, the controller selects an alternative event destination where the preparation times for the plurality of information processing devices on the receiving side are equal to or shorter than the reminder time.

4. The information processing device according to claim 2, wherein the controller selects, based on a capacity of the event destination, the alternative event destination capable of accommodating all users of the information processing devices on the receiving side.

5. The information processing device according to claim 4, wherein when there is no alternative event destination capable of accommodating all the users of the information processing devices on the receiving side, the controller selects alternative individual event destinations for individual information processing devices on the receiving side and allows the communication device to send notification information indicating a change to the alternative individual event destination to each of the information processing devices on the receiving side.

6. The information processing device according to claim 5, wherein when selecting the alternative individual event destinations for the individual information processing devices on the receiving side, the controller sets an online meeting for the plurality of information processing devices on the receiving side and allows the communication device to send the notification information containing information for participation in the online meeting to each of the information processing devices on the receiving side.

7. The information processing device according to claim 6, wherein when, in selecting the alternative individual event destinations for the individual information processing devices on the receiving side, an alternative common event destination is further selectable for any of combinations of members of a group consisting of the plurality of information processing devices on the receiving side based on the capacity of the alternative event destination, the controller selects the alternative common event destination for the combination of members of the group consisting of the information processing devices on the receiving side.

8. The information processing device according to claim 5, wherein in selecting the alternative individual event destinations for the individual information processing devices on the receiving side, the controller selects the alternative event destinations from among the event destinations located within a predetermined short distance from the original event destination.

9. An information notification system comprising a plurality of information processing devices that communicate, for each of a plurality of event destinations, notification information notifying of an event to be held at the event destination via a server on a network, the information notification system including, among the plurality of information processing devices, at least the information processing device according to claim 1 as an information processing device on a sending side that sends the notification information.
